(19) United States
(12) Patent Application Publication
(10) Pub. No.: US 2023/0264656 A1
(43) Pub. Date: Aug. 24, 2023

(54) LAMP DE-ICING SYSTEM

(71) Applicant: Valeo North America, Inc., Troy, MI (US)

(72) Inventors: Minesh Chaudhari, Seymour, IN (US); John Orisich, Seymour, IN (US)

(21) Appl. No.: 17/679,712

(22) Filed: Feb. 24, 2022

(51) Int. Cl. B60S 1/02; B60S 1/56; B60Q 1/00; B60Q 11/00

(52) U.S. Cl. CPC B60S 1/026; B60Q 1/0005; B60Q 11/00; B60S 1/56

(57) ABSTRACT

A lamp de-icing system comprising: one or more heating layers configured to heat one or more regions of a lens of a vehicle; one or more temperature sensors that detect an ambient temperature around the vehicle; one or more humidity sensors that detect an ambient relative humidity around the vehicle; and one or more proximity sensors that detect if precipitation is present on the lens of the vehicle.

### FIELD

The present teachings relate to a light system having a de-icing system that removes precipitation such as ice, snow, or condensation, prevents precipitation from forming, or both.

### BACKGROUND

Vehicles include many different types of lights. Some types of lights included on a vehicle are low beam headlights, high beam headlights, tail lights, turn signal lights, fog lights, running lights, or a combination thereof. These lights function to illuminate areas surrounding the vehicle or to provide notice to other drivers. The vehicles are designed to operate in warm and cold weather; however, cold weather may result in a build up of condensation, snow, or ice on the lights that may impair an amount of light extending around the vehicle. A reduced amount of light may impair visibility of a driver, which could be further impaired by bad weather conditions.

Thus, there is a need for a light system where condensation, snow, ice, or other frozen precipitation that may reduce an amount of light projected outward from a vehicle. There is a need for a prevents a buildup of precipitation such that when a vehicle is first in use the light system is already free of the precipitation. There is a need for a system that senses conditions where a buildup of precipitation may become possible. What is needed is a system that prevents a buildup of precipitation and frozen precipitation while monitoring battery life so as to not drain the battery when a vehicle is unused for an extended period of time.

### SUMMARY

The present teachings provide: a lamp de-icing system comprising: one or more heating layers configured to heat one or more regions of a lens of a vehicle; one or more temperature sensors that detect an ambient temperature around the vehicle; one or more humidity sensors that detect an ambient relative humidity around the vehicle; and one or more proximity sensors that detect if precipitation is present on the lens of the vehicle.

The present teachings provide: a method comprising: monitoring one or more temperature sensors and determining an ambient temperature; monitoring one or more humidity sensors and determining an ambient relative humidity; evaluating the ambient temperature; evaluating the ambient relative humidity; determining a likelihood that precipitation will form on a lens of a vehicle; and activating a lamp de-icing system in communication with a lens of the vehicle if the step of determining determines that it is likely that precipitation will form on the lens of the vehicle.

The present teachings provide a light system where condensation, snow, ice, or other frozen precipitation that may reduce an amount of light projected outward from a vehicle. The present teachings provide a system that a prevents a buildup of precipitation such that when a vehicle is first in use the light system is already free of the precipitation. The present teachings provide a system that senses conditions where a buildup of precipitation may become possible. The present teachings provide a system that prevents a buildup of precipitation and frozen precipitation while monitoring battery life so as to not drain the battery when a vehicle is unused for an extended period of time.

### BRIEF DESCRIPTION OF THE DRAWINGS

FIG. 1 is a side view of a vehicle including a front light system and a rear light system.

FIG. 2A is a side view illustrating a light system with a buildup of precipitation with a de-icing system off.

FIG. 2B is a side view illustrating the light system of FIG. 2A with the de-icing system on.

FIG. 3A a front view of a light system including a de-icing system.

FIG. 3B is a cross-sectional view of a portion of the light system of FIG. 3A along lines IIIB-IIIB.

FIG. 4A is a flow diagram illustrating control of the de-icing system while a vehicle is not running.

FIG. 4B is a flow diagram illustrating control of the de-icing system while the vehicle of FIG. 4A is running.

FIG. 5A is a flow diagram illustrating control of the de-icing system of an electric vehicle while the electric vehicle is not running.

FIG. 5B is a flow diagram illustrating control of the de-icing system of the electric vehicle of FIG. 5A while the electric vehicle is running.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a light system. The light system is located within a vehicle. Preferably, the light system is part of a vehicle such as a car, motorcycle, bus, truck, semi-truck, SUV, XUV, four-wheeler, dirt bike, tractor, combine, heavy equipment, farm equipment, industrial equipment, commercial equipment, or a combination thereof. The vehicle may be gas powered, diesel powered, electric powered, natural gas powered, solar powered, or a combination thereof.

The light system may project light in a forward direction, rear direction, side direction, or a combination thereof. Preferably, the light system projects a light from an external surface of the vehicle to a location in front of the vehicle or at an angle relative to the front or rear of a vehicle. The light system may direct some light at the ground. The light system may direct some light above the ground. The light system may be integrated into a front end, a rear end, or both of a car. The light system may be an assembly. The light system may be a sealed light system that is integrated into a vehicle. The light system may be a sub-assembly that is included in a larger light system. The light system may be integrated into another light system and may function to be part of the light system. The light system may project light out of the vehicle. The light systems may be multiple light systems stacked one above the other or integrated into a single light system. The light system may have multiple smaller light systems or may perform a plurality of light systems. The plurality of light systems may be located in one light system. The plurality of light systems may operate independently of one another such that one light system may not affect another light system or portion of the light system. The light of the vehicle may be two or more, three or more, or four or more light systems located one above another.

The light sources functions to produce light. The light source may be a device or a plurality of devices that create light and the light extends outward from the light source. The light source may produce a high beam, a low beam, a blending beam, a running light, a fog light, a day time light, a turn signal, a brake light, or a combination thereof. The light source may be aimed for near light, far light, blending light that blends the far light and near light together, or a combination thereof. The light sources may have different functions. For example, one light source may provide a running light and another light source may be a turn signal or fog light. The light source may comprise a plurality of lights or may be a single light source within a set of light sources. The plurality of lights may be in one set or group of light sources. The light source may be a single light that projects light. The light source may concentrate light on a light guide, towards a light bar, on a reflector, or a combination thereof. The light source may include a laser diode, glowing phosphor, filament bulb, a light emitting diode, a halogenated light, an xenon light, or a combination thereof. One light source may produce one light function.

The light source may be any type of lighting device that produces light such as an incandescent bulb, fluorescent light, compact fluorescent lamp, halogen lamp, light emitting diode (LED), high intensity discharge lamps (HID); halogen lights, xenon lights, a laser diode, phosphorous bulb, or a combination thereof. The light source may be a single lamp or bulb. Preferably, the light source is part of a set of light sources that includes a plurality of lamps, bulbs, diodes, or a combination thereof. The light source may be part of a set of light sources that includes two or more, 3 or more, 4 or more, or 5 more light sources that produce light and combine together to form the light extending from the light system. The sets of light sources may include 10 or less, 7 or less, 5 or less, or 3 or less devices that produce light (e.g., each set may include 5 light sources or alternatively all of the sets when combined together may include 5 light sources).

The number of light sources in a part of the light may dependent upon a size of the region or a size illuminated. For example, a brake light may have two or more light sources and a turn signal may have a single light. Thus, the light source may be one or more lights, two or more lights, or three or more lights. The light source may be static. The light sources may be free of movement. The light source may be fixed. The light sources may be static and may be manually or physically adjusted so that the light sources are directed to a desired location. The light sources may be fixed and the light from the light source may be moved, bent, directed, or a combination thereof by optical elements or reflectors (e.g., a light guide). Each device of the light source may be turned on and off. The light sources may work together as a set of light sources to create light.

The set of light sources may be a single function (e.g., a high beam, a low beam, a blending beam, a running light, a day time light, a turn signal, a brake light, or a combination thereof). Each set of light sources may perform a single function. Preferably, some of the light systems may include two or more sets of light sources, three or more sets of light sources, or even four or more sets of light sources that provide two, three, or four functions respectively. Each of the sets of light sources may perform a different function or provide a different type of light. All of the lights within a set of light sources may provide the same light (e.g., color, color temperature, or wavelength). For example, one set of light sources may be yellow, orange, or red and a second set of light sources may be white (e.g., OEM white, off white, pure white, or crystal white (e.g., having a color temperature between 4300 K and 6000 K). The color, intensity, temperature, or a combination thereof may vary from set to set depending on the function of the set of light sources. For example, if one set of light sources is directed to a turn signal then the color may be orange whereas if the set of light sources is for a brake light then the color may be red. The color may be determined by a color of an outer lens.

The outer lens or lens may function to protect the light system, house all of the internal components, or both. The lens (e.g., outer lens) may be an outer most part of a light system. The lens may receive all of the light from the lens to be directed outward from the vehicle, in a direction of movement of a vehicle or, both. The lens may be sufficiently strong to protect the light system from rocks and debris as the vehicle moves. The lens may cover all of the light sources, sensors, a high beam, a low beam, a side barker, a turn signal, or a combination thereof of the light system (e.g., a first light bar, a second light bar, or a third light bar). The lens may be transparent, entirely transparent, partially transparent, fully transparent, or a combination thereof. The lens may be hidden. The lens may be covered behind a logo, a colored lens, or both. The lens may provide conspicuity. The lens may have a portion that provided conspicuity and a portion that obscures lights, sensors, or both. The lens may be transparent so that light may extend through the outer lens. The outer lens when covered with precipitation may become more opaque.

The light system functions to provide light, sense surroundings, or both. The light system may include a head light, a high beam, a low beam, lidar, radar, sonar, infrared red camera, a turn signal, a side marker, DRL, cameras, a fog light, a daytime running light, or a combination thereof. The light system may includes one or more regions, two or more regions, three or more regions, four or more regions, or five or more regions.

Each of the regions may include a different component or provide a different function. Each of the regions may include a different light source, a different sensor, or both. The regions may operate at a same time, different times, or a combination of both. Some regions may operate together. The regions may include a turn signal, high beam, low beam, side marker, lidar, sonar, radar, a fog light, daytime running light, or a combination thereof. Each region may include some component (e.g., a sensor) that requires clarity through the lens to operate. For example, light of a headlight, a laser of lidar, or both need to extend through the lens. Any light may extend through the lens (e.g., visible light, non-visible light, or both). The lens may be a forward surface that is contacted by ice, snow, rain, mud, rocks, debris, sleet, road spray, or a combination thereof. Accumulation may occur on the lens. The lens may include a lamp de-icing system or be in contact with a lamp de-icing system.

The lamp de-icing system function to remove, prevent, or both precipitation (e.g., snow, ice, fog, condensation, rain, precipitation events, dew point changes, frost, or a combination thereof) from forming on a lens, blocking light, blocking a signal, or a combination thereof. The lamp de-icing system may generate heat so that the precipitation melts or evaporates. The lamp de-icing system may distinguish between dirt, debris, mud, material that will not melt or evaporate, or a combination thereof and precipitation. The lamp de-icing system may only activate when precipitation is detected. For example, if mud, sand, or some other non-precipitation item is detected, the system may not activate. The lamp de-icing system may clear a lens so that light, signals, or both may pass through the lens. The lamp de-icing system may be connected to the lens, integrated into the lens, or both. The lamp de-icing system may be transparent, include a transparent portion, or permit light and/or signals to pass therethrough. The lamp de-icing system may sense if conditions are present that may generate precipitation. The lamp de-icing system may prevent precipitation from collecting on the lens when the temperature falls below a predetermined temperature, if the humidity raises above a predetermined humidity, or both. The lamp de-icing system may operate when the vehicle is on, the vehicle is off, the vehicle is stationary, the vehicle is moving, or a combination thereof. The lamp de-icing system may include one or more sensors, one or more regions, one or more thermistors, one or more electrodes, one or more cover layers, or a combination thereof. The lamp de-icing system may perform a method of heating.

The heating layers function to generate heat that melts precipitation, evaporates precipitation, or both. The heating layer may extend across a region where light, a laser, a sensor, or a combination thereof extend from a vehicle. The heating layer may be transparent. The heating layer may be woven and light may extend through the heating layer. For example, the heating layer may include wires or resistive material that have spaces that light or signals pass through. The heating layer may be or include a conductive heating file, a coating, an infrared heater, a convection heater, vibration technology, a de-icing liquid, or a combination thereof. The heating layer may include a resistive layer and electrodes within a single layer, that are coplanar, or both. The heating layer may heat to a temperature of about 5° C. or more, about 10° C. or more, about 25° C. or more, or about 40° C. or more. The heating layer may heat to a temperature of about 100° C. or less, about 75° C. or less, or about 50° C. or less. The heating layer may be one or more discrete regions, two or more discrete regions, three or more discrete regions, four or more discrete regions, or eve five or more discrete regions. The regions may operate together. The regions may operate individually. The regions may be operated based upon importance in providing safety. The regions may be operated based upon a sensed amount of precipitation. The regions may be operated based upon a voltage of the battery.

The sensors function to sense precipitation, temperature, humidity, proximity of precipitation to a light and/or sensor, voltage, speed, altitude, or a combination thereof. The sensors may be a precipitation sensor (e.g., is precipitation present). The sensors may be a temperature sensor. The temperature sensors may sense an ambient temperature, a lens temperature, a heater temperature, or a combination thereof. The sensors may sense an altitude of the light de-icing system (e.g., system). The sensor may be a humidity sensor. The humidity sensor may sense a dew point, a relative humidity, a barometric pressure, or a combination thereof. The sensor may be proximity sensor that senses a region and a location of precipitation to the region. The sensor may sense a speed or be in communication with a speed sensor of a vehicle to use the vehicle sensor speed. For example, the sensor may monitor GPS or be a GPS sensor. The sensor may monitor if a vehicle is off, on, moving, or a combination thereof. The sensor is a thermistor. The sensors may be in communication with a processor, a microprocessor, a computer, a vehicle computer, or a combination thereof. The sensors may be in communication with a cloud, a network, surrounding vehicles, or a combination thereof. The sensors may provide weather data. The sensors may monitor weather along a route, navigation in the vehicle, or both. The sensors may communicate with vehicles along the route, a network, a cloud, weather services, news agencies, or a combination thereof. The sensors may monitor radar. The sensors may control the system based upon information from these sensors to predictively activate the system even if the sensors were not currently indicating that the conditions are met. The system may be pre-heated if the sensors indicate that the conditions along the road ahead will likely meet these conditions. When the sensors sense that predetermined conditions are met power and/or electricity are provided to electrodes to power the heating layer.

The electrodes function to distribute electricity, provide electricity along a first side of a heating layer so that the electricity extends from a first electrode on a first side to a second electrode on a second side, or both. The electrodes may include a positive electrode and a negative electrode. The electrodes may extend substantially around the region. The electrodes may distribute electricity so that as the electricity passes through the heating layer the resistance of the heating layer causes the heating layer to heat up. The electrodes may be made of or include gold, silver, copper, nickel, iron, or a combination thereof. The electrodes may be located between, sandwiched between, encapsulated by, or a combination thereof between the heating layer and the cover.

The cover functions to protect the sensor, the heating layer, the electrodes, or a combination thereof. The cover may be made of a dielectric material. The cover may encapsulate one or more sides of the heating layer, the electrodes, the resistive layer, or a combination thereof. The cover resist fluids from entering the lamp-deicing system, the heating layer, the electrodes, the thermistor, or a combination thereof. The cover may be made of or include a polymer, plastic, an acrylic, a polymethyl methacrylate (PMMA), a polycarbonate (PC), polyethylene (PE), a polypropylene (PP), polyethylene terephthalate (PETE or PET), acrylonitrile-butadiene-styrene (ABS), mylar, a polyester, or a combination thereof. The cover may be meltable. The cover may be a film. The cover may be bonded to the heater layer, the resistive layer, another cover, or a combination thereof. For example, there may be a forward cover and a rear cover that are connected together. The cover may be connected to the lens to seal the heater therein. The cover may extend over a resistive layer, be heat stable to a temperature discussed herein that heater may heat, or a combination thereof. For example, as the resistive layer of the heater heats up the cover may not soften, flow, or a combination thereof.

The resistive layer functions to produce heat when electricity is applied to the resistive layer. The resistive layer may be or include a positive temperature coefficient material (PTC), a negative temperature coefficient material (NTC), resistive wires, carbon, a wire mesh, indium tin oxide, or a combination thereof. The resistive layer may be a film, a coating applied to a film, or both. The resistive layer may increase in temperature, have a maximum temperature, or both. The resistive layer may heat one of the regions of the light system. The resistive layer may be located between two electrodes. The resistive layer may electrically connect two electrodes. For example, an electrode on a first side may be electrically connected to an electrode on a second side by the resistive layer. The resistive layer may be heated via a process.

The method may include one or more steps that may be performed in an order discussed herein or a different order than set forth herein. The method may include a step of determining if a vehicle is on or off (e.g., is the engine running). Determining if a vehicle is on or off may only be performed if the vehicle is other than an electric vehicle (e.g., is powered by gas, natural gas, diesel, propane). If the vehicle is not an electric vehicle and the lamp de-icing system is operated while the engine is off the de-icing system may monitor battery health (e.g., how much voltage is available). Based upon voltage available the lamp de-icing system may operate at 100%, operate a reduced heat, operate three or less regions, two or less regions, one region, shut off, or a combination thereof. The lamp de-icing system may continuously monitor a temperature, a humidity, or both for the ambient conditions surrounding a vehicle. The lamp deicing system may turn on if the ambient conditions indicate that the weather may produce precipitation. For example, if the temperature is 1° C. and a relative humidity of 90% the system may be activated due to a likelihood that ice may form. In a different measurement the temperature may be -1° C. with a relative humidity of 20% and the system may not turn on due to the low relative humidity. The temperature and relative humidity may be compared to a look up table, known conditions to produce precipitation, conditions with a high likelihood to precipitation, or a combination thereof. The lamp de-icing system may turn on when the temperature is at or below a threshold temperature and at or above a threshold humidity. The threshold temperature may be about 6° C. or less, 5° C. or less, 4° C. or less, or about 3° C. or less. The threshold temperature may be about 0° C. or more, about 1° C. or more, or about 2° C. or more. The threshold humidity may be about 50 percent or more, about 60 percent or more, 65 percent or more, or about 70 percent or more. The threshold humidity may be about 100 percent or less, about 90 percent or less, about 80 percent or less, or about 75 percent or less.

Once the temperature and humidity are measured the lamp de-icing system evaluates the temperature and humidity to determine if precipitation is likely to form. The processor may be a processor of the vehicle, a stand alone processor in the lamp de-icing system, or both. The evaluation may compare both the measured temperature and the measured humidity to a threshold temperature and a threshold humidity. The threshold humidity and the threshold temperature may vary with one another. For example, the lower the temperature the lower the humidity may be before the lamp de-icing system is activated by the processor, microcomputer, or both. The evaluation may determine to turn on the lamp de-icing system or turn off the lamp de-icing system. If a determination is made to keep the lamp de-icing system off or to turn the lamp de-icing system off then the lamp de-icing system will continue to monitor the ambient conditions. If a determination is made to turn on the lamp de-icing system then the lamp de-icing system may determine if the vehicle is on or off.

If the lamp de-icing system turns on and the vehicle is off then a battery voltage may be determined. If the battery voltage is determined to be high then the lamp de-icing system may operate all of the regions, operate at low, intermediate low, intermediate high, or high. Preferably, when running on battery with a full battery the lamp de-icing system will operate at intermediate low (e.g., 25 percent to 50 percent) or intermediate high (e.g., 50 percent to 75 percent). If the battery is determined to have a high amount of charge (e.g., the battery is 50-75 percent charged or voltage is measuring at 12 volts) but less then full charge the lamp de-icing system may power less regions then would be powered if full power is detected (e.g., 1 region less than full power), provide a lower amount of heat, operate a low, operate at intermediate low, or a combination thereof. For example, if the lamp de-icing system detects that the battery is beginning to run low then the lamp de-icing system will deactivate heating in one region or two regions so that the remaining regions can continue to be heated. If the battery is determined to have an intermediate charge (e.g., 25 percent to 50 percent or voltage is between 11.5 volts and 12 volts) then the system may deactivate one or more regions, two or more regions, or three or more regions. For example, if there are four regions the system may only activate one region. The lamp de-icing system (e.g., system) may lower an amount of power provided to the regions. For example, the system may provide power at about 50 percent or less or 25 percent or more power so that some heat is applied to the lens to maintain some condensation removal. If the battery is determined to have a low charge then the system may be completely turned off, all of the regions may be turned off, an amount of time the system is on may be reduced by 75%, the amount of regions powered may be reduced to a single region, the power supplied may be about 25% of full power, or a combination thereof. If the vehicle is running then the system may not monitor battery voltage. If the vehicle is an electric vehicle then battery voltage may be monitored. If the vehicle is an electric vehicle then battery voltage may not be monitored. If the system determines that the temperature, humidity, voltage, vehicle status, or a combination thereof are all proper then the system may then measure a proximity of the precipitation to a region.

The proximity sensor functions to determine if precipitation is present, if precipitation is located within a region (e.g., an area where light or a sensor monitors through the lens), of any portion of the region includes precipitation, if the region is covered by precipitation or some other contamination (e.g., bugs, mud, or the like), or a combination thereof. The proximity sensors may sense each of the regions individually (e.g., each region may include a sensor). The proximity sensors may sense each of the regions simultaneously. The system may include one or more proximity sensors, two or more proximity sensors, three or more proximity sensors, or four or more proximity sensors. The system may include an equal number of proximity sensors and regions. The system may include one proximity sensor. The proximity sensors may determine if precipitation is present, not present, is precipitation, is opaque, is transparent, or a combination thereof. The proximity sensor may determine if precipitation is present or not.

If the system determined that precipitation is not present then system may apply power to the heater to prevent precipitation from forming on the lens. The system may apply power for maintenance as a preventative measure. The system may apply power to the heater so that the heater is on low or intermediate low. The system may apply a steady amount of power. The system may apply power in an amount between about 0 percent and about 75 percent, about 25 percent and 60 percent, and between about 40 percent and 50 percent of full power. The system may continue to provide power to the heater while all of the conditions above continue to be met. The system may stop providing power if the temperature increases, humidity decreases, voltage availability decreases, or a combination thereof. The system may change an amount of power provided if one or more of the measured conditions changes. For example, the system may decrease power if the temperature increases. The system may increase power if the proximity sensor detects precipitation.

If precipitation is detected, then an amount of power may be increased to reduce or eliminate the precipitation. If precipitation is sensed then the power may be increased from low to intermediate low, intermediate low to intermediate high, intermediate high to high, low to intermediate high, intermediate low to high, or a combination thereof. If precipitation is detected the amount of power applied may be increased by 25 percent of a full load. If precipitation is detected, then the power may be increased to 75 percent of a full load. If precipitation is detected, then the regions that include safety functions or regulatory functions may have increased power. For example, regions with a head light, daytime running light, a sensor, radar, lidar, or a combination thereof. Detection of precipitation by the proximity sensor may power the system to 50 percent or more, 75 percent or more, or full power. If precipitation is detected, then the system may determine if the vehicle is moving or is stationary.

If the vehicle is stationary, then the system may power the heater to intermediate high or high. If the vehicle is stationary, then the system may apply steady power. If the vehicle is stationary then the system may apply power at 75 percent or more, 80 percent or more, 90 percent or more, or 100 percent of full power. Once precipitation is detected and no movement is detected then the heater is turned on. The heater may remain on until one of the measured conditions (e.g., temperature, humidity, proximity, speed, or a combination thereof) changes.

If a speed change is detected, then the system may change an amount of power applied. If the speed is greater than 0 Km/hr then the heater may be powered to intermediate high or high. If the vehicle is moving, then the heater may be powered to full power. If the vehicle is moving, then the heater may be overpowered. Depending on the speed of the vehicle will determine an amount of power applied to the heater (e.g., heating layer). The amount of power applied may be a steady amount of power (e.g., full power). The heater may be powered over full power when the vehicle is moving at a high rate of speed (e.g., 50 km/hr or more or even 100 Km/hr or more). The speed sensor may be a gps sensor, a speed sensor of the vehicle, or both. The heater may be overpowered by applying a continuous amount of power. Thus, as the resistance of the heater increases an amount of power applied may be applied to the heater. Power may be applied to heat the heater to a power rating limit so that the heater melts precipitation or prevents precipitation from building on a lens. Once the amount of power to be applied is determined then the system may turn on. For example, a circuit of the system is turned on.

Once the circuit of the system is turned on, the system may still continuously monitor the sensors for changes in the ambient conditions, the vehicle conditions, or both. The circuit may power the system, the heater, the heating layer, the sensors, or a combination thereof. The circuit may be part of the vehicle, a circuit of the vehicle, or a combination thereof.

The circuit may have an override. The override may allow a user to turn the system on, turn the system off, or both. The override may be an internal switch. The override may be a button inside of the vehicle. The override may be turned on and may automatically turn off when the vehicle is turned off, after a predetermined amount of time, or both. The override may allow a user to activate the system when the conditions sensed do not appear to be met. The system may have one or more feedback loops that intermittently or continuously monitor the sensors when the override is not in use.

The feedback loops function to monitor the sensors to determine if the system needs to be turned on or if the system needs to be turned off. The feedback loops may measure temperature, humidity, voltage, proximity, or a combination thereof. The feedback loops may monitor the sensors continuously. The feedback loops may monitor the sensors about 5 times or more, 10 times or more, 20 times or more, 30 times or more, 60 times or more, or even 100 times or more per minute. The feedback loops may determine whether the conditions are met to turn on or off the system.

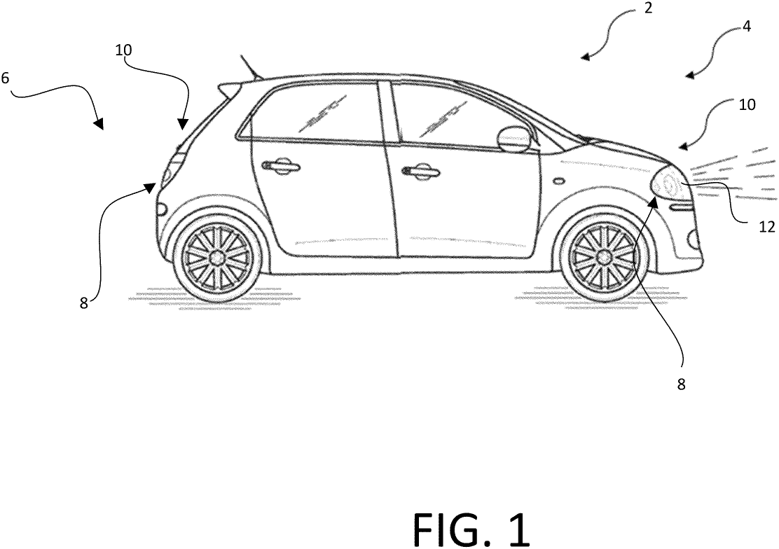

FIG. 1 illustrates a side view of a vehicle 2 including light systems 10. The light systems 10 are located at the front end 4 and the rear end 6. The light system 10 at the front end 4 and the rear end 6 each include a turn signal 8. The light system 10 at the front end 4 includes a head light 12.

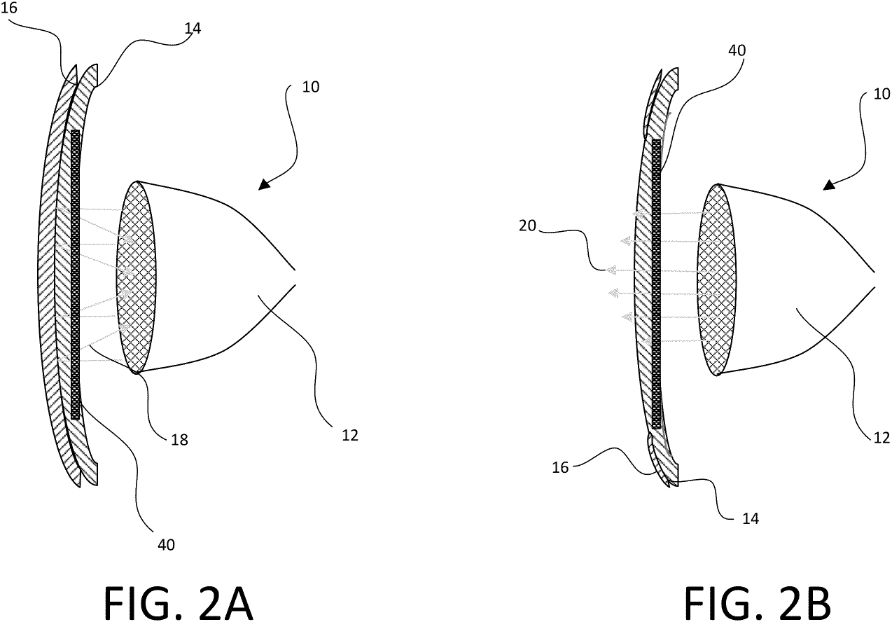

FIG. 2A illustrates a side view of a light system 10. The light system 10 includes a head light 12 and a lens 14. The lens 14 is covered in precipitation 16 such as snow or ice due to the lamp de-icing system 40 being off. The precipitation 16 causes reflected light 18 such that less light passes through the lens 14.

FIG. 2B illustrates a side view of the light system 10 with the lamp de-icing system 40 being on. As shown, the lamp de-icing system 40 heats the lens 14 so that the precipitation 16 is removed (e.g., melts or evaporates). With the precipitation 16 removed the light 20 passes through the lens 14 to illuminate a region with the head light 12. The lamp de-icing system 40 removes all of the precipitation 16 in a region where the light 20 passes through the lens 14; however, some precipitation 16 may remain present.

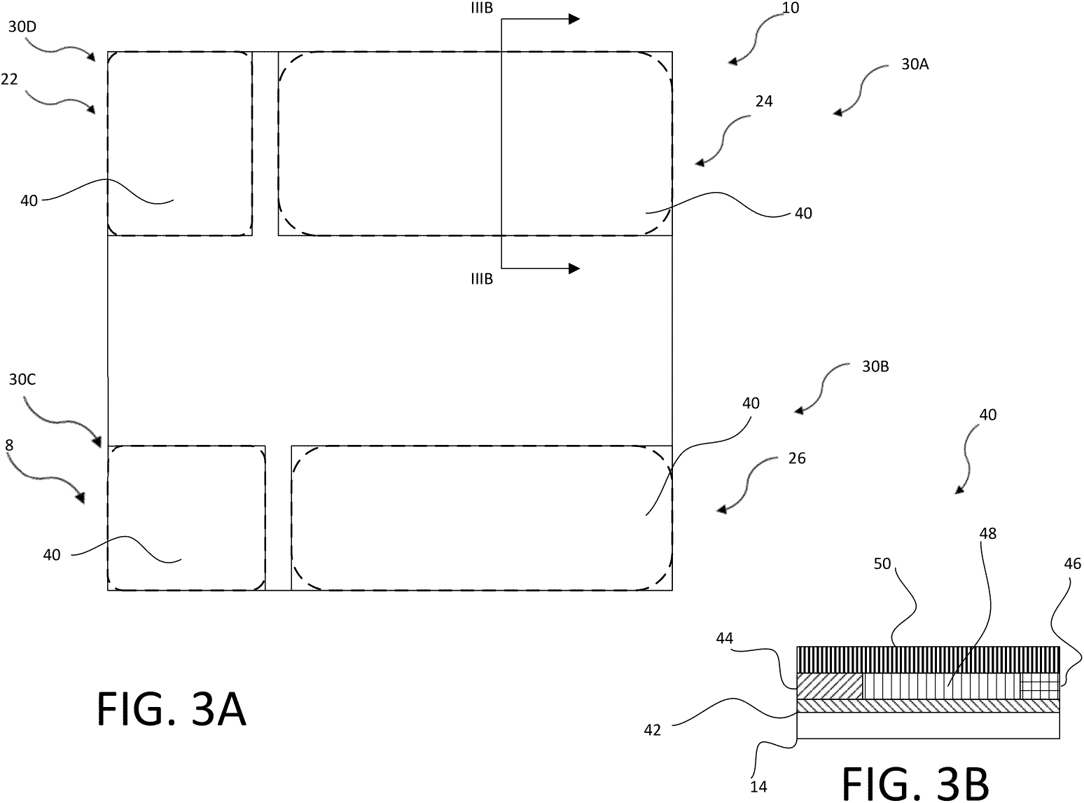

FIG. 3A illustrates an example of a light system 10. The light system 10 includes four light regions 30A, 30B, 30C, and 30D. The four light regions are a turn signal 8, a sidemarker 22, a high beam 24, and a low beam 26. Each of the four light regions include a lamp de-icing system 40. Each of the four light regions provide light for a different purpose.

FIG. 3B illustrates a cross-sectional view of the Lens 14 and lamp de-icing system 40. The lamp de-icing system 40 is connected to the lens 14. The lamp de-icing system 40 includes a heating layer 42. On the heating layer 42 is a thermistor 44, electrodes 46, and a resistive layer 48. A cover 50 extends over the heating layer 42, the thermistor 44 and the electrodes 46.

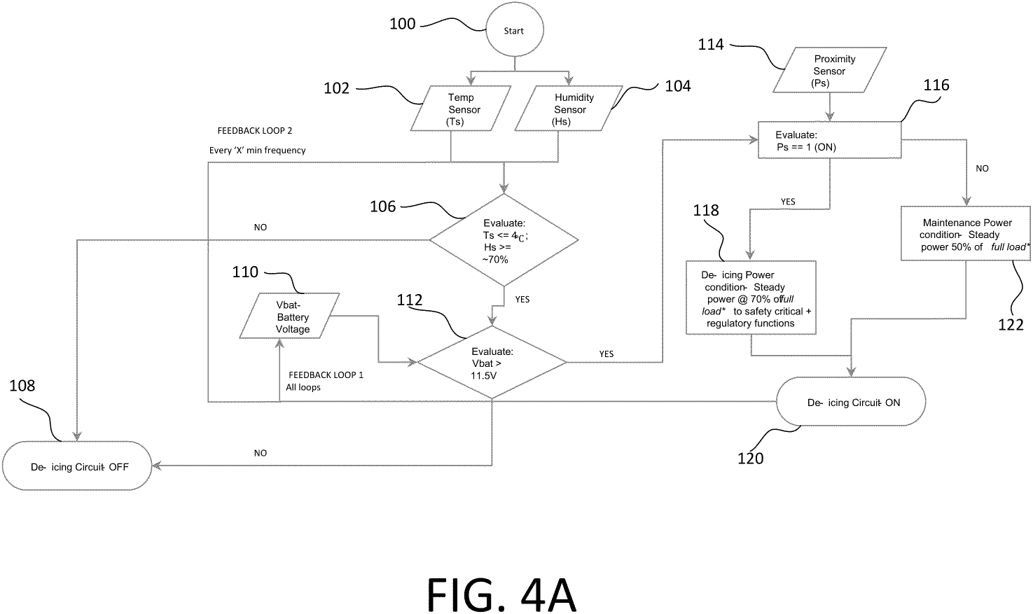

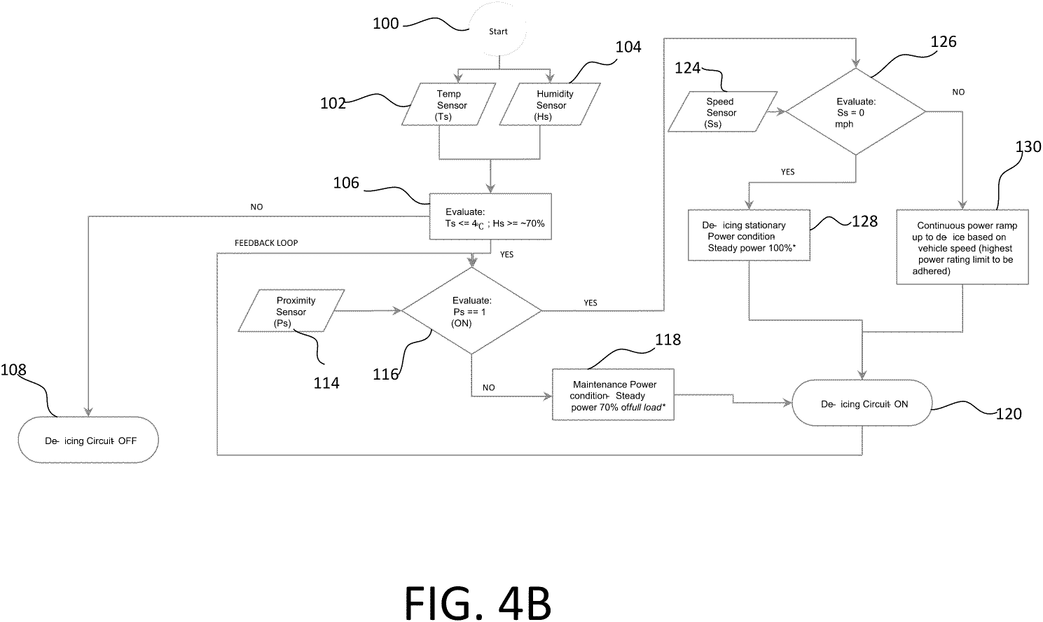

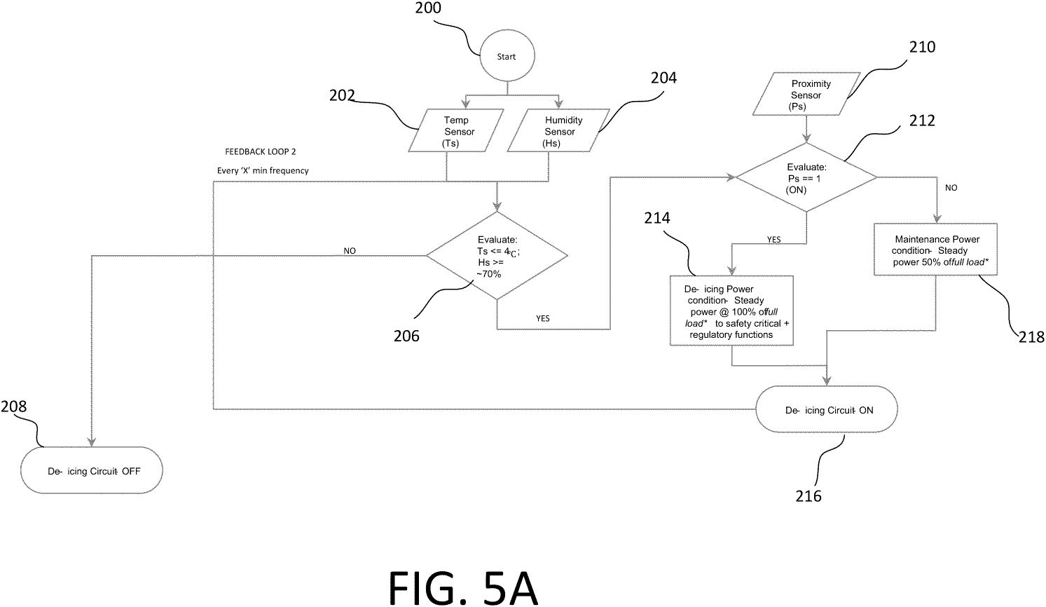

FIG. 4A illustrates a flow diagram illustrating control of a lamp de-icing system 40 when a gas powered vehicle is off. A processor or controller (not shown) starts 100 by taking a temperature with a temperature sensor 102 and a humidity with a humidity sensor 104. The temperature and humidity are then evaluated 106 to determine if precipitation (e.g., fog, snow, ice) conditions are present (e.g., above a predetermined humidity and/or under a predetermined temperature). As shown, evaluation 106 determines if the temperature is over 4° C. and over 70% humidity. If the evaluation 106 determines that the precipitation conditions are not present, then the de-icing circuit remains off 108. If the evaluation 106 determines that one or both of the precipitation conditions are present, then the processor measured voltage of a battery 110. The voltage is then assessed 112 to determine if there is sufficient voltage in the battery to power the lamp de-icing system. If the assessment 112 determines there is not sufficient voltage then the de-icing circuit remains off 108. If the assessment 112 determines that there s sufficient voltage then the processor or controller determines proximity 114 of any precipitation to a proximity sensor (e.g., a region surrounding a light or a sensor). The proximity 114 of the precipitation is then evaluated 116 to a region were light or sensors pass. If the precipitation is close to the region (e.g., a portion of the lens is blocked) then the lamp de-icing system 40 is turned to intermediate low 118 and then the de-icing circuit is turned to on 120. If the precipitation is evaluated 116 is not proximate to the region then the power is turned on low 122 and the de-icing circuit is turned to on 120.

FIG. 4B illustrates control of a lamp de-icing system 40 when a gas powered motor is running. The processor or controller (not shown) starts 100 by taking a temperature with a temperature sensor 102 and a humidity with a humidity sensor 104. The temperature and humidity are then evaluated 106 to determine if precipitation (e.g., fog, snow, ice) conditions are present (e.g., above a predetermined humidity and/or under a predetermined temperature). As shown, evaluation 106 determines if the temperature is over 4° C. and over 70% humidity. If the evaluation 106 determines that the precipitation conditions are not present, then the de-icing circuit remains off 108. If the evaluation 106 determines that the precipitation conditions are present, then the processor with a proximity sensor 114 determines 116 if precipitation is in a predetermined region or proximate to the predetermined region. If it is determined 116 that precipitation is not in the predetermined region or proximate to the predetermined region then the de-icing system 40 is powered to an intermediate low 118 power and then the de-icing circuit is turned on 120. If the evaluation 116 determines that precipitation is present in the predetermined region or proximate to the predetermined region then speed is monitored with a speed sensor 124. The speed is then evaluated 126 to determine if the speed is above a predetermined speed. If the evaluation 126 determines that the speed is above the predetermined speed then the de-icing system is powered to intermediate high 128 and the de-icing circuit is turned on 120. If the evaluation 126 determines that the speed is above a predetermined speed then the de-icing system is powered to high 130 and turned on 120.

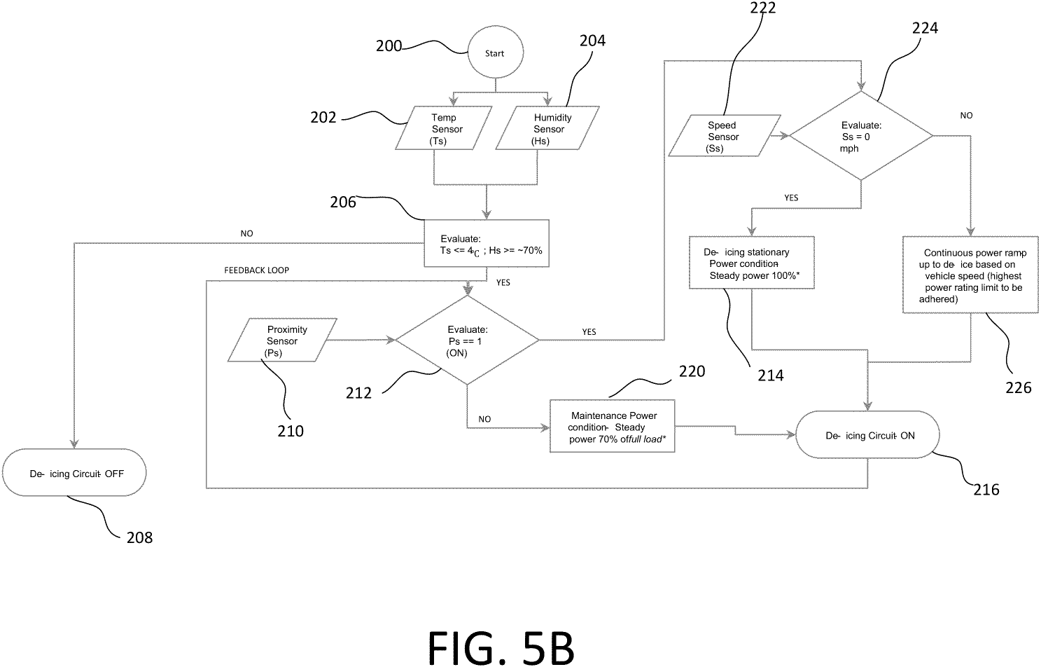

FIG. 5A illustrates a flow diagram illustrating control of a lamp de-icing system 40 when a battery powered vehicle is off. A processor or controller (not shown) starts 200 by taking a temperature with a temperature sensor 202 and a humidity with a humidity sensor 204. The temperature and humidity are then evaluated 206 to determine if precipitation (e.g., fog, snow, ice) conditions are present (e.g., above a predetermined humidity and/or under a predetermined temperature). As shown, evaluation 206 determines if the temperature is over 4° C. and over 70% humidity. If the evaluation 206 determines that the precipitation conditions are not present, then the de-icing circuit remains off 208. If the evaluation 206 determines that one or both of the precipitation conditions are present, then the processor or controller determines proximity 210 of any precipitation to a proximity sensor (e.g., a region surrounding a light or a sensor). The proximity 210 of the precipitation is then evaluated 212 to a region were light or sensors pass. If the precipitation is close to the region (e.g., a portion of the lens is blocked) then the lamp de-icing system 40 is turned to intermediate high 214 and then the de-icing circuit is turned to on 208. If the precipitation is evaluated 206 is not proximate to the region then the power is turned on low 218 and the de-icing circuit is turned to on 208.

FIG. 5B illustrates control of a lamp de-icing system 40 when an electric vehicle is running. The processor or controller (not shown) starts 200 by taking a temperature with a temperature sensor 202 and a humidity with a humidity sensor 204. The temperature and humidity are then evaluated 206 to determine if precipitation (e.g., fog, snow, ice) conditions are present (e.g., above a predetermined humidity and/or under a predetermined temperature). As shown, evaluation 206 determines if the temperature is over 4° C. and over 70% humidity. If the evaluation 206 determines that the precipitation conditions are not present, then the de-icing circuit remains off 208. If the evaluation 206 determines that the precipitation conditions are present, then the processor with a proximity sensor 210 determines 212 if precipitation is in a predetermined region or proximate to the predetermined region. If it is determined 212 that precipitation is not in the predetermined region or proximate to the predetermined region then the de-icing system 40 is powered to an intermediate low 220 power and then the de-icing circuit is turned on 216. If the evaluation 212 determines that precipitation is present in the predetermined region or proximate to the predetermined region then speed is monitored with a speed sensor 222. The speed is then evaluated 224 to determine if the speed is above a predetermined speed. If the evaluation 224 determines that the speed is above the predetermined speed then the de-icing system is powered to intermediate high 218 and the de-icing circuit is turned on 216. If the evaluation 224 determines that the speed is above a predetermined speed then the de-icing system is powered to high 226 and turned on 216.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

ELEMENT LIST

| | |
|---|---|
| 2 | Vehicle |
| 4 | Front End |
| 6 | Rear End |
| 8 | Turn Signal |
| 10 | Light System |
| 12 | Head Light |
| 14 | Lens |
| 16 | Precipitation |
| 18 | Reflected Light |
| 20 | Light |
| 22 | Side marker |
| 24 | High Beam |
| 26 | Low Beam |
| 30A | Region 1 |
| 30B | Region 2 |
| 30C | Region 3 |
| 30D | Region 4 |
| 40 | Lamp De-icing System |
| 42 | Heating Layer |
| 44 | Thermistor |
| 46 | Electrode |
| 48 | Resistive layer |
| 50 | Cover |
| 100 | Start |
| 102 | Sense Temperature |
| 104 | Sense Humidity |
| 106 | Evaluate Temp and Humidity |
| 108 | Off |
| 110 | Detect Battery voltage |
| 112 | Evaluate battery condition |
| 114 | Determine proximity |
| 116 | Evaluate the proximity |
| 118 | Turn power to intermediate low on heater |
| 120 | Turn circuit on |
| 122 | Turn power to low |
| 124 | Determine speed of a vehicle |
| 126 | Evaluate the speed |
| 128 | Turn sensor on intermediate high |
| 130 | Turn sensor on high |
| 200 | Start |
| 202 | Sense temperature |
| 204 | Sense humidity |
| 206 | Evaluate temp and humidity |
| 208 | Off |
| 210 | Determine proximity |
| 212 | Evaluate proximity |
| 214 | Turn power to intermediate high |
| 216 | Turn circuit on |
| 218 | Turn power to low |
| 220 | Turn power to intermediate low |
| 222 | Determine Speed |
| 224 | Evaluate speed |
| 226 | Turn power to high |

I claim:

1. A lamp de-icing system comprising:
one or more heating layers configured to heat one or more regions of a lens of a vehicle;
one or more temperature sensors that detect an ambient temperature around the vehicle;
one or more humidity sensors that detect an ambient relative humidity around the vehicle; and
one or more proximity sensors that detect if precipitation is present on the lens of the vehicle.

2. The lamp de-icing system of claim 1, wherein the lamp de-icing system determines if the vehicle is on.

3. The lamp de-icing system of claim 1, further comprising a speed sensor that detects a speed of the vehicle.

4. The lamp de-icing system of claim 1, further comprising a voltage detector to detect a voltage of the vehicle.

5. The lamp de-icing system of claim 1, further comprising a processor that monitors the one or more heating layers, the one or more temperature sensors, the one or more humidity sensors, the one or more proximity sensors, or a combination thereof and controls the lamp de-icing system.

6. The lamp de-icing system of claim 1, wherein the lamp de-icing system prevents precipitation from forming on the lens by heating the lens when the one or more humidity sensors detect the ambient relative humidity being above a predetermined threshold and the one or more temperature sensors detect the ambient temperature being below a predetermined temperature threshold.

7. The lamp de-icing system of claim 6, wherein the lamp de-icing system prevents precipitation from forming while the vehicle is off.

8. The lamp de-icing system of claim 1, wherein the one or more proximity sensors detect precipitation around a region of the lens.

9. The lamp de-icing system of claim 8, wherein the region of the lens is a region that light extends through, a sensor detects through, or both.

10. The lamp de-icing system of claim 1, wherein the lamp de-icing system comprises four discrete heating layers that each heat a different region of the lens of the vehicle.

11. A method comprising:
a. monitoring one or more temperature sensors and determining an ambient temperature;
b. monitoring one or more humidity sensors and determining an ambient relative humidity;
c. evaluating the ambient temperature;
d. evaluating the ambient relative humidity;
e. determining a likelihood that precipitation will form on a lens of a vehicle; and
f. activating a lamp de-icing system in communication with a lens of the vehicle if the step of determining determines that it is likely that precipitation will form on the lens of the vehicle.

12. The method of claim 11, further comprising monitoring a status of the vehicle to determine if the vehicle is on.

13. The method of claim 12, further comprising monitoring battery voltage of a battery of the vehicle so that the lens de-icing system does not completely drain the battery while the vehicle is off.

14. The method of claim 11, further comprising a proximity sensor that detects precipitation proximate to one or more regions of the lens of the vehicle.

15. The method of claim 14, wherein the lamp de-icing system is powered with a low amount of power or an intermediate low amount of power when no precipitation is detected.

16. The method of claim 14, wherein the lamp de-icing system is powered with an intermediate high amount of power or a high amount of power when precipitation is detected.

17. The method of claim 11, further comprising detecting a speed of the vehicle when the vehicle is on.

18. The method of claim 17, wherein the lamp de-icing system is powered with an intermediate low amount of power or an intermediate high amount of power when the vehicle is on but not in motion.

19. The method of claim 17, wherein the lamp de-icing system is powered with an intermediate high amount of power or a high amount of power when the vehicle is on and in motion.

20. The method of claim 11, wherein the lamp de-icing system remains off when the ambient temperature is above a predetermined threshold temperature, the ambient relative humidity is below a predetermined threshold relative humidity, or both.
